(19) United States
(12) Patent Application Publication
(10) Pub. No.: US 2017/0240461 A1
(43) Pub. Date: Aug. 24, 2017

(54) METHOD OF COATING A SUBSTRATE

(71) Applicant: DSM IP ASSETS B.V., Heerlen (NL)

(72) Inventors: Romain CAUCHOIS, Echt (NL); Guido Jozefina Wilhelmus MEIJERS, Echt (NL); Robin Elisabeth Maria Jacobus DAENEN, Echt (NL)

(21) Appl. No.: 15/519,613

(22) PCT Filed: Oct. 21, 2015
(86) PCT No.: PCT/EP2015/074370

§ 371 Date: Apr. 17, 2017

(30) Foreign Application Priority Data
Oct. 21, 2014 (EP) 14189807.2

(51) Int. Cl. C03C 17/00; G02B 1/11; C03C 17/25

(52) U.S. Cl. CPC C03C 17/007; C03C 17/25; G02B 1/11; C03C 2218/112; C03C 2218/113

(57) ABSTRACT

A method of coating a substrate is disclosed. The method comprising the steps of that includes providing a substrate having a first surface, providing a particle based coating composition comprising particles, applying the coating composition to at least a part of the first surface of the substrate, and converting the particle based coating composition on the first surface of the substrate into a functional coating having a thickness of 50 nm to 25 μmas measured along across section in a scanning electron microscope (SEM), wherein the particle based coating composition comprises nanoparticle, and converting the particle based coating composition involves a high intensity energy source heating at least a part of the coating composition, wherein the high intensity energy source is selected from the group of certain CO2 lasers and flame arrays. Furthermore an apparatus for preparing a coating is disclosed.

### TECHNICAL FIELD OF THE INVENTION

The invention relates to a method of coating a substrate. More particularly, the invention relates to a method of manufacturing a substrate with a functional coating, such as an optical coating, coated substrates as well as apparatus for manufacturing coated substrates.

### BACKGROUND OF THE INVENTION

Optical coatings, such as anti-reflective (AR) coatings, may be provided on surfaces requiring high transmission of light, such as cover glasses for photovoltaic modules and display substrates. AR coatings can be sol-gel based. Such coatings may be applied on the cover glass plate before the fabrication of the photovoltaic module with successive deposition, conveying and oven curing (herein also referred to as conversion) at temperatures below the melting point of the coated substrate (of for example 600-700° C.) before the assembly of the photovoltaic module. This allows for a continuous and affordable process. The high temperature of 600-700° C. can be applied to ensure tempering of the glass substrate if needed and also ensures proper optical and/or mechanical properties, good coating durability and proper removal of any organic components like solvents, surfactants, viscosity modifiers and polymers. However, coating prior to assembly exposes the new coating to damage, such as scratching issues, during the subsequent production process where the coated substrate is utilized for example in manufacturing of photovoltaic modules. Damage may for example be caused during contact with the transport equipment like conveying rolls or belts, robot handlers etc., and/or handling when applying the coated glass to an assembly or when applying active layers on the glass surface opposite to the coating. An example of a coating composition requiring such high temperature oven conversion treatment is for example disclosed in US 2010 015433.

An AR coating could be provided on a photovoltaic module assembly near the end of the production line, i.e. after the cover glass has been incorporated into the assembly. In this case, the temperature and time, which can be applied during the oven curing of the applied coating composition, is limited by the heat sensitive components forming part of the assembly and exposure of such components should be limited to below about for example 100-150° C. and times of lower than about for example 10-30 s. Examples of heat sensitive materials present in a module are polymeric encapsulant and/or back sheet materials and optional (edge) sealant materials and optional semiconductor or transparent conductive oxide (TCO) or conductive layers. There are examples where so-called skin heat technology has been applied to achieve surface temperatures at around 250° C.-300° C., however, sol-gel based coatings treated under such process conditions may exhibit issues, such as reduced durability or optical properties due to incomplete conversion of the coating composition.

U.S. Pat. No. 8,815,340 discloses a method of increasing the degree of crystallization or the size of crystallites as part of the deposition of conductive or semi-conductive thin film. The thin film is provided on a surface of a glass substrate whereafter the substrate is treated by a heat source having a plurality of linear flame treatment devices and the length of each of the flame treatment devices must be less than or equal to a third of the width of the glass substrate. In U.S. Pat. No. 8,815,340, bending of the substrate is indicated to be a major complication of the treatment and this complication is only overcome—or in fact limited to bending of less than 150 mm—by the use of the required setup of the burners.

DE102009018908 discloses a method of closing the pores in the outermost surface part of a porous antireflective coating by heating the surface under infrared radiation, UV radiation, heat treatment, laser sintering, or by means of microwave radiation.

### OBJECTS OF THE INVENTION

It is the object of the invention to provide an improved method of coating a substrate.

In another aspect of the invention, it is an object of the invention to provide an improved coated substrate.

In a further aspect of the invention, it is an object of the invention to provide an improved apparatus for coating a substrate.

The improvement may for example be achieving one or more advantages of high temperature converting of a coating composition without heating all of the substrate to the high temperature, or another feature of the invention.

### DISCLOSURE OF THE INVENTION

In a first aspect of the invention, the object is achieved by a method according to claim 1.

A further aspect concerns an apparatus according to claim 13.

### BRIEF DESCRIPTION OF THE DRAWINGS

The invention will be explained more fully below with reference to exemplary embodiments as well as the drawings, in which

FIG. 1 shows schematic flowcharts of methods and apparatus for coating a substrate, and

FIG. 2 shows optical properties of 3.2 mm float glass,

FIG. 3 shows flash test results of coated and uncoated modules,

FIG. 4 shows surface roughness test results,

FIG. 5 shows various flame arrays

FIG. 6 shows a sketch of a tilted flame array while treating a substrate,

FIG. 7 shows an embodiment of a flame conversion unit with height adjustable flame array and feedback loop,

FIG. 8 shows optical properties of a coated substrate,

FIG. 9 shows loss in transmission after mechanical testing a coated substrate coatings,

FIG. 10 shows optical properties of a coated thin flexible glass substrate, and

FIG. 11 shows the sodium content profile for unconverted coatings and coatings converted by oven, flame and laser conversion.

All figures show only steps which are necessary in order to elucidate the invention, other parts being omitted or merely suggested.

### DETAILED DESCRIPTION

By particle based coating composition is herein meant a coating composition comprising numerous solid particles and a solvent (and optionally additives such as binders, viscosity modifiers and surfactants) for example in a suspension. The particles may for example be glass particles, metal oxides, or coating precursors that will form particles at least temporarily during conversion of the coating composition into the coating. Examples of such solid particles are composed of nanoparticles having a particle size of 1 to 150 nm such as for example dense (i.e. not porous or hollow) nanoparticle (such as sol-gel glass particles of for example 1-5 nm), hollow particles, such as silica-glass based shells with for example air or solvent inside and core-shell particles with a polymer containing core and a silica-glass or silica glass precursor shell (such as for example known from WO2008/028641, incorporated herein by reference).

By assembly is herein meant a partially or fully assembled photovoltaic module comprising at least two members selected from the group consisting of a glass member forming at least a part of the first surface of the substrate, a thin film transparent conductive and/or semiconductor layer, a back sheet, a sealant, an encapsulant, an electrical conducting film, wiring, a junction box and a frame. Back sheets may for example include glass, polymeric film or other material that provide the properties of the back sheet needed for the specific photovoltaic module design and application area and are known in the art. Preferable the assembly is a partially assembled photovoltaic module not comprising frame and/or junction box as such assemblies was found to be advantageous to coat before connect the frame and junction box to the partially assembled photovoltaic module.

The coating composition may be applied by techniques know in the art, such as dip coating, roll coating, kiss coating, slot die coating, curtain coating, spray coating, curtain coating, and aerosol coating. The thermal process could also be used to thermally process or sinter layers deposited by physical vapour deposited layers or chemical vapour deposited layers in a controlled fashion optionally simultaneously with conversion of a coating composition.

The substrate is a solid material. Preferably, the substrate is a glass member or a polymer member, such a glass sheet member or a polymer sheet member. More preferably, the substrate is a glass member being selected from the group of float glass, chemically strengthened float glass, borosilicate glass, structured glass, tempered glass, and thin flexible glass as well as substrates comprising a glass member, such as a partially or fully assembled photovoltaic module and an assembly comprising a glass member. By thin flexible glass is herein meant a glass sheet having thickness in the range of for example 20 to 250 μm such as 50 to 100 μm. Preferably, the partially or fully assembled photovoltaic modules are modules comprising a glass member forming at least a part of the first surface of the substrate. It would be appreciated that the present method allows for coating of substrates that do not allow for heating of the bulk of the substrate to a temperature that degrades a component of the substrate. Such degradation may for example take place by exposure of the substrate to above 200° C., such as above 300° C., such as about 600° C., for several minutes, which is required for conventional conversion of sol-gel based coating compositions into a functional coating. Furthermore, it was observed that converting a coating composition on an assembly rather than on a cover glass alone lead to a less bending of the substrate during the converting step. Reduced bending during conversion is advantageous since it may result in a more uniform conversion or a lower (risk of) damage to the assembly. It could be theorized without being limited thereto that this may be related to the module being structurally more stable than the cover glass alone—particularly for thin glass applications. Preferred substrates for the method according to the invention are hence tempered glass, chemically strengthened glass and substrates comprising temperature sensitive components, such as partially or fully assembled photovoltaic modules.

By a functional coating is herein meant a coherent coating that enhances mechanical, optical, anti-soiling, durability, weatherability and/or electrical properties of the substrate to which the functional coating is attached. Enhanced mechanical properties is for example increased surface hardness, increased stiffness or wear properties as compared to the mechanical properties of the substrate; enhanced optical properties is for example increased light transmittance from air through the functional coating and substrate compared to light transmittance directly from air through the substrate, and reduced reflectance from the interface from air to the functional coating and the functional coating to the substrate compared to the reflectance directly from air to substrate; enhanced anti-soiling properties is for example reduced particle accumulation on the coated surface; enhanced electrical properties is for example increased conductivity as compared to the unconverted coating and/or to the uncoated substrate.

By the first surface of the substrate is herein meant the whole or a part of the surface of the substrate. For a sheet shaped substrate, the first surface can therefore refer to both the whole one side of the sheet or to a selected part of a side of the sheet.

In the first aspect of the invention, the particle based coating composition comprises nanoparticles, preferably the coating composition comprises a sol-gel comprising a metal oxide or a precursor of a metal oxide, more preferably the coating composition comprises core-shell nanoparticle having an core material comprising polymer and a shell material comprising metal oxide.

Coating compositions comprising nanoparticles are for example coating compositions with silica and/or metal oxide particles in the size range of 10-200 nm, and optionally a porogen, such as an organic nanoparticle, which organic nanoparticle is removed during conversion and hence form porosity in the functional coating, or hollow (inorganic) particle. After conversion, a porous structure is formed between the silica and/or metal oxide particles or where the porogen has been removed. Other examples of coating compositions comprising nanoparticles are the preferred embodiments of coating compositions.

Coating compositions comprising a sol gel comprising metal oxide or a precursor of a metal oxide are for example coating compositions with pre-oligomized metal oxide precursor (such as tetramethyl orthosilicate, tetraethyl orthosilicate, metal alkoxide, like for example aluminum methoxide or ethoxide). Such coating compositions may also comprise other (non-sol gel) particles such as for example metal oxide particles, or porogen. Other examples of coating compositions comprising sol gel are the preferred embodiments of coating compositions.

Coating composition comprises core-shell nanoparticle having an core material comprising polymer and a shell material comprising metal oxide are for example coating compositions as described in WO2008/028640.

In the conversion of coating compositions into a functional coating, such as an optical anti-reflective coating, it is preferred that polymer material as well as other organic material if present in the as-applied coating, is removed and the metal oxide network is formed, such as a silica network or metal oxide comprising silicon. It should be understood that in this field, silica is considered a metal oxide and that the term silica network here includes networks of mixed metal oxides comprising —O—Si—O-type bindings. Conventionally, conversion is done in a conversion or curing oven, such as a tunnel or tempering oven, where polymer and other organic material if present in the as-applied coating will have several minutes to evaporate, depolymerize or go through pyrolysis, which all involves a multifold increase in volume of the organic component, as well as the metal oxide network can be formed. Surprisingly, it was found that this process could be conducted at very high speed without compromising the structure of the functional coating, i.e. achieving the same or similar structure, such as pore structure, as realized by conventional conversion in a conversion oven. Particularly, it was surprisingly found to be possible to remove the polymer core material from the core-shell nanoparticle and convert a coating composition comprising core-shell organic-inorganic nanoparticles into the functional coating comprising hollow shells, i.e. without compromising the shell part of the core-shell structure, when converting the particle based coating composition involves a high intensity energy source heating as defined in claims. The short time required to reach a functional coating is particularly surprising since in general, sol-gel silica coatings typically is considered to require extended time for reaching a useful coating which it could be theorized (without being limited thereto) to be caused by the conversion from coating composition to functional coating on a substrate involving breakage/formation of —Si—O—Si— bonds.

The coating thickness of the functional coating is measured along a cross section in a scanning electron microscope (SEM). It is preferred that the thickness of the converted functional coating is between 50 nm to 25 μm. The highest part of this range, such as for example 1 μm to 25 μm is for example advantageous for functional coatings improving the mechanical or blocking properties of the substrate. The thinnest part of the range, such as for example 50 to 300 nm or 50 to 250 nm are particularly advantageous to functional coatings improving the optical properties of the substrate.

In one aspect of the invention, the high intensity energy source is an energy source that is able to increase the temperature of a part of the coating composition on the substrate to a surface temperature of at least 800° C. with a heating ramp of at least 1000° C./s and holding the temperature above 600° C. for at least 0.5 and no longer than 5 s. Examples of high energy sources are flame arrays and high energy lasers. It should be observed that a conventional tunnel oven is not a high intensity energy source, as such an oven does not allow for so rapid heating of the coating composition.

The laser is a CO₂ laser capable of supplying a power of 100 W to 10.000 W onto a treatment area. Preferably the treatment area is realized by the laser beam scanning repeatedly over the treatment area. The Treatment area is the area that is covered during one scan of the laser beam, in other words, the treatment area represents the total target area of the laser, which is repeatedly scanned. Irrespective of the scan speed, the energy output of the laser is distributed to this area and during conversion, the substrate is moved through this area for example by the substrate being moved by aa conveyer or this area is moved over the sample for example by (robot) arm moving the laser. To realize a good balance between having sufficiently high power density to realize the required temperature for conversion to take place with limited or no damage to the substrate, it was found that the target area should be between 0.25 to 30 cm² and preferably 1.5 to 15 cm², such as most preferably 2 to 12 cm², and the power density, i.e. the power divided by the treatment area, should be 100 W/cm² to 1000 W/cm².

The flame array is a unit that delivers one or more lines or extended areas of flames, which flames typically are so closely arranged that they form one flame sheet or wall. The power of the flame array should be between 5 kW to 100 kW per meter flame array, preferably 15 kW/m to 75 kW/m, and more preferably 20 kW/m to 50 kW/m and should be directed towards the substrate. By directed towards the substrate is meant that the flame time is not pointing away from the substrate. It was found that the minimum distance from the flame array to the substrate should be between 3 mm to 70 mm, preferably 3 to 30 mm, more preferably 4 mm to 20 mm, more preferably 5 mm to 15 mm, such as 6 mm to 12 mm during use. The highest distances are particularly useful for heat sensitive substrates and thin flexible glass substrates.

Since the back of the substrate or elements of the substrate may be heat sensitive, it is highly preferred that the second surface of the substrate arranged on the opposite side of the first surface of the substrate will remain at a temperature of below 200° C. during the conversion of the coating composition into a functional coating as measured with a thermocouple connected to the surface by scotch tape or a thermocouple embedded in an encapsulant layer below the substrate or otherwise connected. More preferably the opposite side of the first substrate will remain at a temperature of below 150° C. and more preferably at a temperature of below 120° C. and most preferably at a temperature of below 100° C. during the conversion of the coating composition on the first surface of the substrate.

In a preferred embodiment, the maximum centre temperature of a standard sample is lower than 200° C. during the conversion of coating composition. The standard sample is a sandwich of two glass sheets with a thermoscouple arranged therebetween as described in details in Example 21. It was found that the maximum centre temperature of a standard sample provided a good steering tool to identify conversion conditions acceptable for typical conversion of coating composition on assemblies with a cover glass, i.e. identify conditions where substrate deterioration is prevented or kept at acceptable level. Particularly, maximum centre temperature of a standard sample was a highly useful way to measure if a suitable combination of supplied energy, treatment area, power density (W/cm²), minimum distance and sample speed (which ever relevant for the chosen high intensity energy source) was used when treating assemblies comprising a heat sensitive component. More preferably the maximum centre temperature of a standard sample is lower than 150° C., more preferably at a temperature of below 130° C., and more preferably at a temperature of below 120° C. and most preferably at a temperature of below 100° C. during the conversion of the coating composition on the first surface of the substrate.

The energy delivered to the coating is depending on the number of energy sources, the substrate speed, the burner to surface distance, the tilt angle and the number of passes. The total energy supplied to the coating should be sufficient to convert the applied coating formulation into the functional coating while the opposite side of the first surface of the substrate will remain at a temperature of below 200° C. or preferably the lower preferred maximum centre temperatures indicated above. The temperature on the opposite side of the first surface of the substrate has been found to be well estimated using the standard sample as indicated above and described in Example 21.

In the process of conversion of the coating composition into a functional coating, it may be required to use more subsequent treatments by high intensity energy sources as defined herein to achieve complete conversion of the coating composition. Use of more treatment by high intensity energy sources has the advantage that less energy is required in each treatment and hence the heating of the substrate during the conversion can typically be reduced leading to reduced risk of substrate failure. The subsequent treatments may take place using the same high intensity energy source more than one time or by arranging several high intensity energy sources sequentially. It is preferred to use a maximum of 3 sequential treatment, to ensure a balance between conversion speed and apparatus investment.

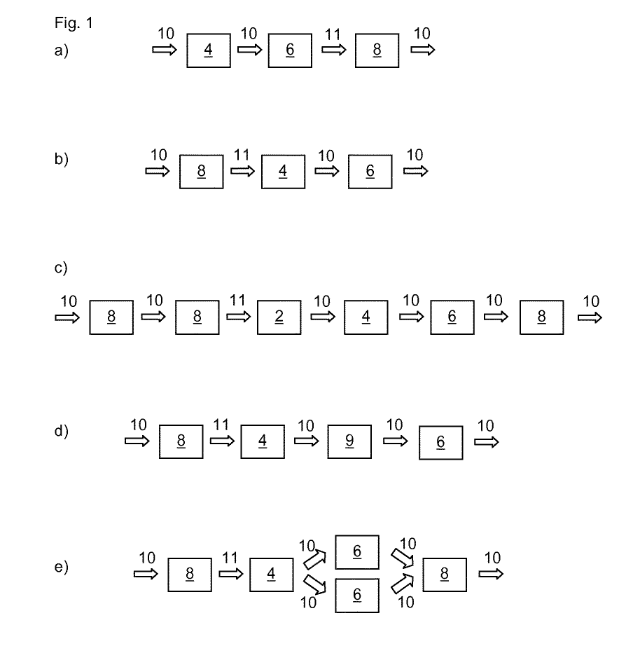

In a preferred embodiment, the substrate is moving continuously or semi continuously during converting with an effective linear speed of at least 0.5 m per min. Higher speeds are advantageous, as it allows for more substrates being treated by one production line and hence preferably with a linear speed of at least 0.75 m per minute and more preferably with a speed of at least 1 m per minute. The linear speed is typically less than 20 m per min to ensure a stable and reproducible heating profile, and preferably with a linear speed of less than 10 m per minute, such as a linear speed of less than 5 m per minute or a speed of less than 4 m per minute. The highest effective linear speed may for example be realized by using a plurality of high intensity energy sources, such as two, three, four or up to 10 high intensity energy sources treating the substrate or a part of the substrate at the same time or sequentially. Another way to reach a high effective linear speed is to conduct the converting in two or more parallel stations as for example indicated in FIG. 1e. By effective linear speed is herein meant the average speed of substrate between entering the converting station and leaving the converting station. A station where the substrate moves continuously with constant speed of 1 m/min will therefore have an effective linear speed of 1 m/min. A station where a substrate of 1 m length in the machine direction is treated 1 minute while the substrate is stationary or moving at slow speed (for example by a moving energy source or a moving target site for a laser beam relative to the substrate) has an effective linear speed of 1 m/min since 1 m of substrate is treated in 1 minute. A converting station being fed from one assembly line and having two converting lines running in parallel and in each line the substrate moves continuously with constant speed of 0.5 m/min will therefore also an effective linear speed of 1 m/min. In a preferred embodiment, the linear speed is constant so the effective linear speed of the substrate is the same as the linear speed of the substrate. A conversion station where the substrate moves continuously with a constant speed of 0.5 m/min and a (robot) arm with flame array treats the substrate while the flame array moves with a constant speed of 0.5 m/min in the opposite direction than the substrate also has an effective linear speed of 1 m/min since 1 m of substrate is treated in 1 minute.

In some cases, it is preferred to not coat the whole side of the substrate, for example, if the coating composition is electrical conductive or semi-conductive and a certain pattern of ‘cabling’ is desired or if the edges of a substrate will not be active, so coating composition can be saved by not coating such areas. Then the coating composition may be applied in a pattern covering 50 to 95% of the first surface of the substrate. One way of realizing this is that the coating method further comprises the step of applying a template member covering 5 to 50% of the first surface of the substrate before applying the coating composition. Alternatively, it may be realized by the method further comprising the step of applying a template member covering 5 to 50% of the first surface of the substrate with applied coating composition before converting the coating composition on the first surface of the substrate. Preferably, the method further comprises the step of recycling the coating composition that is caught by the template member or not being converted on the substrate due to the template member covering part of the surface of the substrate.

It was found in some cases to be advantageous to provide a protective frame on or near the substrate before converting the coating composition. Particularly, this was the case when the frame provides heat protection of heat sensitive parts on or near the edges of the substrate. In one method, the protective frame is applied to or near the substrate before the step of applying the coating composition on the substrate.

The method described under the first aspect of the invention may be used for different types of applications, however, it was found to be highly advantageous to use the method to coat a substrate with a coating having a thickness of 50 nm to 300 nm as this corresponds to about ¼ of the wavelength of the visible light and hence has major advantages as AR coating for example for photovoltaic module and display glass applications. The coating may comprise one or more layers having the same function (such as anti-reflective, where layers with different refractive index may lead to overall improved anti-reflective properties of the coating) or different function (such as one barrier layer and one anti-reflective layer).

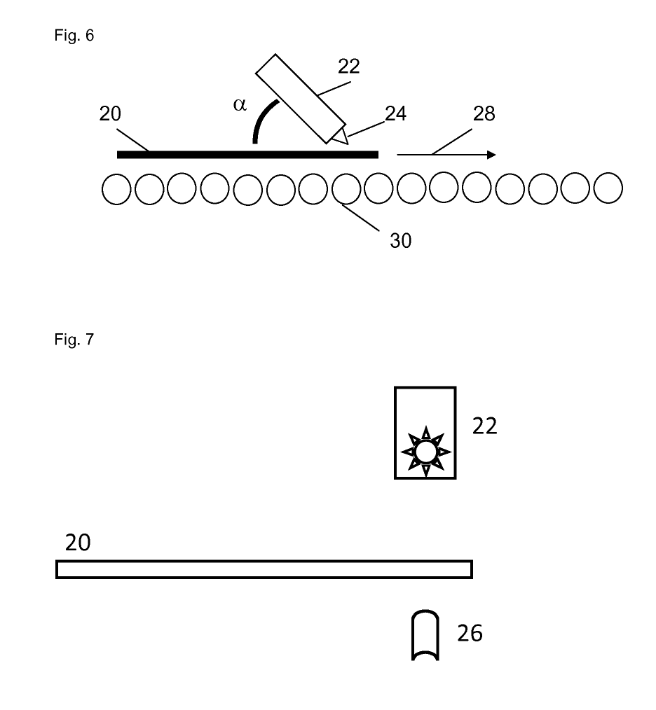

It was found to be highly advantageous that the high intensity energy source is a flame, and particularly a linear flame array was found to be advantageous. Such a linear flame array may preferably be arranged at an angle to the machine direction of the first surface of the substrate during conversion. In FIG. 6, an example of arrangement of a linear flame array, 22, with an angle, α, is shown schematically. Furthermore, arranging of the flame array with an angle, α, of 30-90° to a plane of the first surface of the substrate during converting was found to reduce the risk of glass breakage, particularly when the substrate is a sheet of glass and hence not an assembly. Particularly, arranging the array with the angle of 30-80°, preferably 60-75° to a plane of the first surface of the substrate, 20, during converting (as indicated in FIG. 6) was found to promote safe operating of the flame array for substrates consisting of a glass. This means that the flame tip, 24, is pointing in the direction, 28, that the substrate is moving towards on the conveyer, 30, during conversion of the coating composition into the functional coating.

For substrates, 20, consisting of an assembly, it was found to be preferred to arrange the flame orthogonal to the surface to be treated (i.e. with an angle α of 90°) or at an angle very closed to orthogonal, such as an angle α of 80-90°, more preferably 82-88°.

As indicated above, it was found to be advantageous to use a flame as high intensity energy source. However, the high intensity of the flame may lead to bending of the substrate and it was found to be highly advantageous for the coating quality to at least partially compensate for the bending of the substrate. In one method, the bending of the substrate is compensated by using a flame array, wherein at least a part of a flame array is vertically displaceable to accommodate for bending of the substrate during converting for example by measuring bending of the substrate at least one place along the flame array and actively adjust the distance and/or shape of the flame array accordingly via a feedback loop. In FIG. 7 a system according to this embodiment is shown. Here a height sensor, 26, is arranged below the assembly, 20, during conversion and as the assembly bends, the degree of bending is measured by the height sensor whereafter the high energy heat source, 22, such as a flame array, is displaced accordingly to keep the distance between the flame array to the substrate constant. It was found that a feedback loop utilizing a frequency of 0.2 to 100 Hz was suitable and preferred frequency was 1-15 Hz. A suitable setup is shown in FIG. 7. In another method of compensating for the bending of the substrate, the array comprises at least one permanently curved and/or staged linear flame array or permanently curved linear flame array segment. Examples of schematic views of linear flame arrays, 22, as seen from the side looking in the machine direction are shown in FIG. 5 with the flame, 24, indicated. A curved linear flame array, 22, is shown in FIG. 5a, an example of a staged linear flame array, 22, is shown in FIG. 5b, and an example of a straight linear flame array is shown in FIG. 5c. Another useful way is to compensate by adjusting the flame length and/or temperature for example by adjusting the nozzle opening, the gas pressure or composition along the length of the flame array (not shown).

The gas used is preferably an affordable, combustible gas or gas mixture (i.e. a combustible gas and an oxygen source, such as air or oxygen gas). Preferred gasses are natural gas, natural gas/air mixtures, hydrogen, hydrogen/air, hydrogen/oxygen mixture, propane, propane/air mixture, acetylene, acetylene/air mixture. Mixtures are advantageous in that the released energy is very predictable as only the flow of one gas needs to be adjusted. Gasses mixed onsite with oxygen source is advantageous in that the ratio of the gasses can be adjusted freely and hence reducing gas mixtures and oxidizing gas mixtures easily can be used according to the need for the used coating composition.

Another aspect of the invention concerns a photovoltaic module comprising a substrate coated according to the first aspect of the invention. The substrate may be a cover glass or an assembly comprising the cover glass and one or more further elements as disclosed elsewhere herein.

The apparatus is suitable for providing a functional coating to a substrate and comprises a coating application station for applying a particle based coating composition to a first surface of a substrate, a converting station for converting the particle based coating composition on the first surface of the substrate into a functional coating, an assembly station for providing at least one member selected from the group consisting of a back sheet, an encapsulant, an electrical conducting film, wiring, controller box and a frame, in connection with a second surface of the substrate, a substrate conveyer for transporting the substrate between at least two of the stations, wherein at least one assembly station is arranged sequentially before the coating application station and wherein the converting station comprises a high intensity energy source selected from the group consisting of a laser and a flame array. In this embodiment, it was found to be highly advantageous when the high intensity energy source comprises a flame or a laser, such as one or more flame arrays or one or more lasers. It is preferred that the at least one assembly station arranged sequentially before the coating application station is arrange inline with the coating application station and the converting station so the substrate is transported directly between these stations for example by conveyers and optionally via buffer stations. However, in one embodiment, the at least one assembly station arranged sequentially before the coating application station, coating application station and converting station is arranged offline with at least one of the other stations. In this case, substrates may be stored or transported or even shipped to another location before being treated in the next station. For example, an assembly station may prepare a substrate comprising the full photovoltaic module except for framing and coating whereafter the substrate is transported offline to a location (in the same building or another building, which other building may be arranged next door or at a substantial distance, such as next town, another country or another continent) where further steps in the process are conducted.

In FIG. 1a, an example of the conventional arrangement of the apparatus stations is indicated, where the coating is applied to the substrate, 4, and converted, 6, into a functional coating before turning the substrate around and assembling the further components of the module with the coated substrate in the assembly station, 8. The arrangement has the problem that the very sensitive coating is already applied before assembling the module and hence there is a risk of damaging the coating during the assembly step.

In FIG. 1b, an example of an apparatus according to the invention for providing a functional coating on a substrate is shown. A cover glass is provided by a substrate conveyer, 10, to the assembly station 8, where various components are applied to the cover glass to form the substrate in one or more assembly stations. Since the components applied to the cover glass are applied to the opposite side of the cover glass than the first surface where the functional coating should be applied, the substrate conveyer 11 turns the substrate whereafter the substrate is provided to the application station, 4. It should be observed that it may be advantageous to assemble the substrate in time and distance separated from the application station, such as preparing the substrates in one facility and applying the coating in another. In that case, it is highly advantageous to add a substrate pre-treatment step (such as a washing step, a drying step and/or a surface activation step like for example plasma cleaning/activation or corona treatment) between the assembly station and the application station as it was found that this improved the quality of the final functional coating. This arrangement of a substrate pre-treatment step in a pre-treatment station, 2, is indicated in FIG. 1c. If a substrate pre-treatment step is used, it is preferred that the substrate pre-treatment step is conducted immediately before application of the coating composition to the first surface of the substrate. The substrate conveyer 10 is preferably automated and work continuous or semi-continuous throughout the apparatus, but manual labour may also act as a substrate conveyer by manually transporting the substrate to and from and/or through the stations of the apparatus. In the application station, 4, coating composition is applied to the a first surface of the substrate. Examples of application stations are spray coating stations, roll coating stations, slot die coating stations, kiss coating stations, curtain coating stations, aerosol coating stations and dip coating stations. Thereafter the coating is transported by the substrate conveyer 10 to the conversion station 6. The conversion station is for example a flame conversion station or a laser conversion station. After the conversion station, the functional coating such as an AR coating is ready. In some cases, extra assembly for example application of a frame, wiring or connection of a control component may be required in a separate step as indicated in FIG. 1c.

It should be observed that a pre-treatment step may advantageously also be included in other embodiments of the apparatus according to invention.

The apparatus may also include a buffer station, 9, arranged between other stations, 2,4,6,8, connected by the conveyer, 10,11. Such a buffer station, 9 may for example take into account different treatment rate in the stations or prevent stopping of more stations if one station is temporarily stopped. In FIG. 1d, an apparatus according to the invention and having a buffer station is depictured. Here, the buffer station, 9 is arranged after the coating is applied in the coating station, 4, and before the converting station, 6.

The conveyers, 10,11, preferably transport the substrate inline from one station, 2,4,6,8,9 to another station 2,4,6,8,9 of same or different type of station. By inline is here included the situation where buffer station is arranged between the stations connected by the conveyer. Such a buffer station may take into account different treatment rate in the stations or prevent stopping of more stations if one station is temporarily stopped. The conveyers may also transport the substrate offline from one station, 2,4,6,8,9 to another station 2,4,6,8,9. In this case, substrates may be stored or transported or even shipped to another location before being treated in the next treatment station. An example of such an offline process would be the substrate is an assembly and the assembly is assembled in one location and coating application onto the substrate and conversion of the coating composition are conducted later in another location.

In one embodiment, the same type of stations may be arranged in parallel if one station is substantially faster or slower than other stations. An apparatus according to this concept is shown in FIG. 1e, where the coating conversion is conducted in two separate conversion stations.

A great advantage of the apparatus according to one aspect of the invention where the substrate is an assembly comprising most or all elements to be arranged on the opposite side of the cover glass than the first surface (where the coating is to be applied) is that it is possible to use a substrate conveyer that interacts with the first surface of the substrate in at least one station before the coating application station and the substrate conveyer does not interact with the first surface of the substrate in and after the coating application station. Here, interact with the first surface means that a part of the substrate conveyer touches at least a part of the first surface directly or via a protective member. This allows for a rather simple and safe handling of the substrate during assembly and allows for a rather simple handling during application and conversion of the coating composition as substrate conveyer then can interact with the back and optionally the edges of the substrate. In other words, there is no time where the sensitive coating has to be touched during conveying of the substrate.

### EXAMPLES

### Example 1: Application of Coating Composition to Float-Type Glass Substrate (Standard Glass)

A float-type substrate (from Pilkington, 10×20 cm, standard K-edged, with a thickness of 3.2 mm, with a composition compliant with DIN EN 572) is coated on a single side with MP Coat AR T1 coating composition (commercially available from DSM, The Netherlands; MP Coat AR T1 was formerly sold under the trade name KhepriCoat®) by dip coating at a dipping speed of 3.5 mm/s under controlled relative humidity (below 40%) and room temperature of 20-25° C. Thereafter the substrate is dried at room temperature for 24 h under the same conditions as coating condition (below 40% RH and 25° C.).

This yielded a substrate with a single sided unconverted sol-gel coating having core-shell particles with cores comprising polymeric material and silica based shell with an unconverted coating thickness below 300 nm.

### Example 2: Application of Coating Composition to Assembly with Float-Type Glass Substrate (Module)

Example 1 was repeated with the difference that the substrate was replaced with a photovoltaic module having an uncoated cover glass and using roll coating. Dimension 120×60×0.68 cm

Example 2 yielded a module with a single sided unconverted sol-gel coating having core-shell particles with cores comprising polymeric material and silica based shells with an unconverted coating thickness below 300 nm.

### Example 3: Conversion of Dried Coating Composition Obtained in Example 1 by Flame Conversion

As high intensity energy source a linear flame array of a length of 10 cm (i.e. wider than the substrate) was used. In this way, the array always extended beyond the edges of the substrate. In the setup, the substrate was moved with constant linear speed under the flame array. The flame array was oriented at an angle of 60° so the flame pointed towards the direction that the glass was moved as indicated in FIG. 6. The distance between the substrate and the flame array was 10 mm. A gas mix of hydrogen (H₂) and oxygen (O₂) in a mix of 24:9 was burned yielding a power of about 70 kW/m and a theoretical flame maximum temperature of about 2800° C. The temperature on the back of the substrate was measured during conversion with a thermocouple attached to the back of the substrate by tape. The maximum temperature measured was 122° C.

A sample from Example 1 was treated at a speed of 65 cm/min and resulted in a substrate with a stable appearing coating.

### Example 4: Conversion of Dried Coating Composition Obtained in Example 2 by Flame Conversion

As high intensity energy source a straight linear flame array of a length of 60 cm (i.e. wider than the substrate) was used. In this way, the array always extended beyond the edges of the substrate. In the setup, the substrate was moved with constant linear speed under the flame array. The flame array was oriented at an angle of 30° so the flame pointed towards the direction that the glass was moved as indicated in FIG. 6. The distance from flame to substrate was 20 mm. A gas mix of propane (16 nL/min) and air (460 nL/min) was burned yielding a power of about 25 kW/m and a theoretical flame maximum temperature of about 1980° C.

8 samples from Example 2 was treated at a speed of 65 cm/min and resulted in substrates with stable appearing coatings.

### Example 5 (Comparative): Treating of Substrate without Coating Composition by Flame Conversion

An uncoated substrate of the type used in Example 1 was treated using a linear flame array of a length of 60 cm (i.e. wider than the substrate) as high intensity energy source. In the setup, the substrate was moved with a constant linear speed of 60 cm/min under the flame array. The flame array was oriented at an angle of 60° so the flame pointed towards the direction that the substrate was moved (as indicated in FIG. 6) and with a distance of 15 mm between the straight linear flame array and the substrate. A gas mix of methane and air was burned yielding a power of 20 kW/m linear flame array and yielding a theoretical flame maximum temperature of about 1800° C.

This resulted in a substrate with no visual difference as compared to the untreated substrate.

### Example 6 (Comparative): Treating of Substrate without Coating Composition by Flame Conversion

An uncoated substrate of the type used in Example 2 was treated under same conditions as described in Example 4.

This resulted in a substrate with no visual difference as compared to the untreated substrate.

### Example 7 (Comparative): Conversion of Dried Coating Composition of Example 1 in Oven

A sample from Example 1 was converted in the conventional way by heating in a bench top oven for 3.5 min at 650° C.

This resulted in a coated substrate with a stable appearing coating.

### Example 8: Optical Test and Flash Test

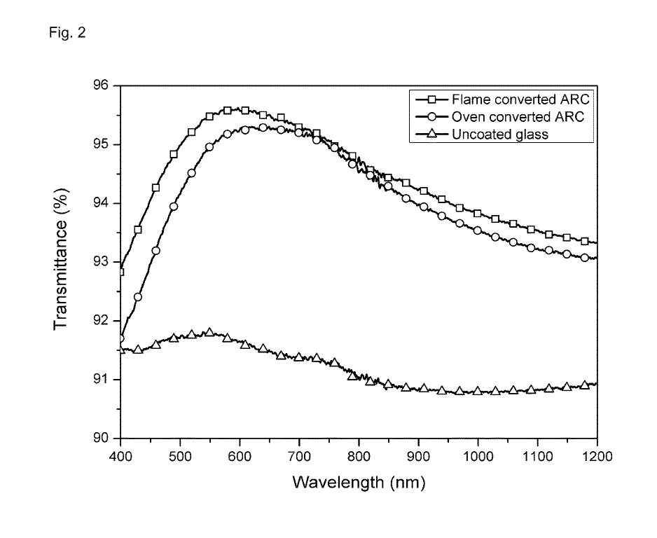

The optical transmittance of samples obtained in Examples 3, 5 and 7 were analysed by UV-Vis spectrophotometry (UV-2600 from Shimadzu) equipped with an integrating sphere. FIG. 2 depicts the transmittance curves in the visible and near-infrared spectrum, for a wavelength comprised between 400 and 1200 nm. It is observed that the sample flame converted according to the invention exhibits higher transmission than the sample converted by conventional oven treatment. The improvement of the average transmission on a wavelength range comprised between 380 to 850 nm compared to uncoated glass is 2.9% for oven converted sample and 3.4% for flame converted sample according to the invention.

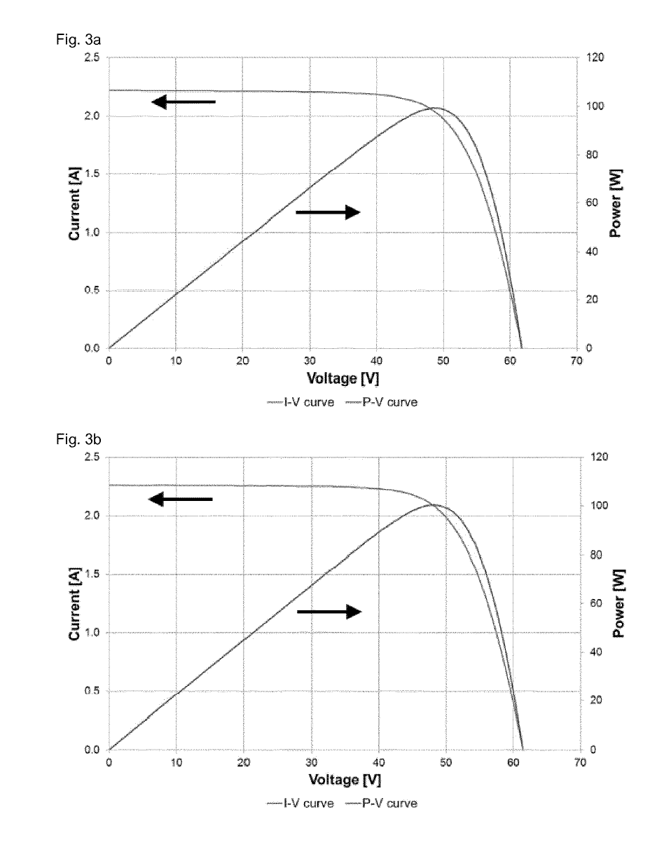

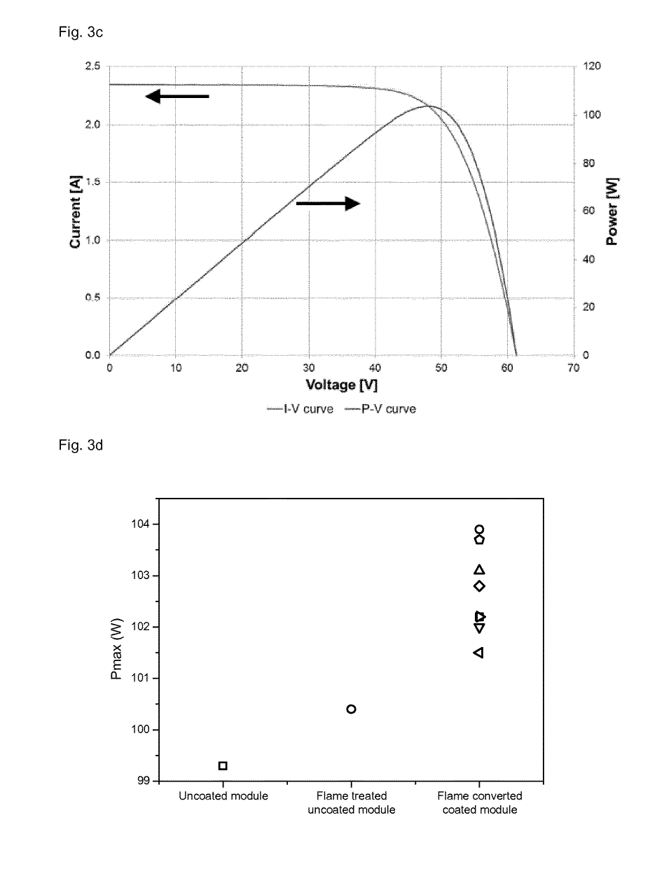

The samples obtained in Example 4 and 6 were analysed by Flash test by measurement of I-V curve at standard test conditions according to IEC 60904-1:2006 and IEC 60904-3:2008, measurement of spectral response according to IEC 60904-8, and computation of spectral mismatch coefficient and correction of I-V characteristic according to IEC 60904-7. In FIG. 3 the results for glass substrates are compared. It is observed that the result of for flame converted samples according to the invention is equivalent and in some areas even marginally better than the sample prepared by conventional oven conversion.

On FIG. 3a is represented the IV and PV curves of the uncoated photovoltaic module, acting as a reference. The maximum power output of this panel under flash test condition is 99.3 W. On FIG. 3b is depicted the IV and PV curves of a similar photovoltaic module uncoated and treated as described in Example 6, showing identical properties with a maximum power output under flash test condition of 100.4 W. On FIG. 3c is depicted the IV and PV curves of a similar photovoltaic module first roll-coated, dried 24 h and then flame converted under the conditions of Example 4. The maximum power output of this panel under flash test conditions is 103.9 W, i.e. a relative gain of 4.6% in power output compared to uncoated module. 8 modules were measured, and the average maximum power output is 102.7 W, i.e. an average relative gain of 3.4% in power output compared to uncoated module. In FIG. 3d, the results are summarized.

### Example 9: Surface Roughness

The surface morphology of samples obtained in Example 3, 5 and 7 was characterized by AFM (MultiMode 8 from Bruker) in tapping mode using a silicon cantilever. Average and root-mean square surface roughness of the coating is calculated on a surface of 2 μm×2 μm using Nanoscope software according the following formula:

$${R}_{a} = \frac{1}{n} {\sum }_{i = 1}^{n} \vert {z}_{i} \vert {R}_{q} = \sqrt{\frac{\sum {z}_{i}^{2}}{n}}$$

Where Zi is the height of every measured point and n the number of points within the given area.

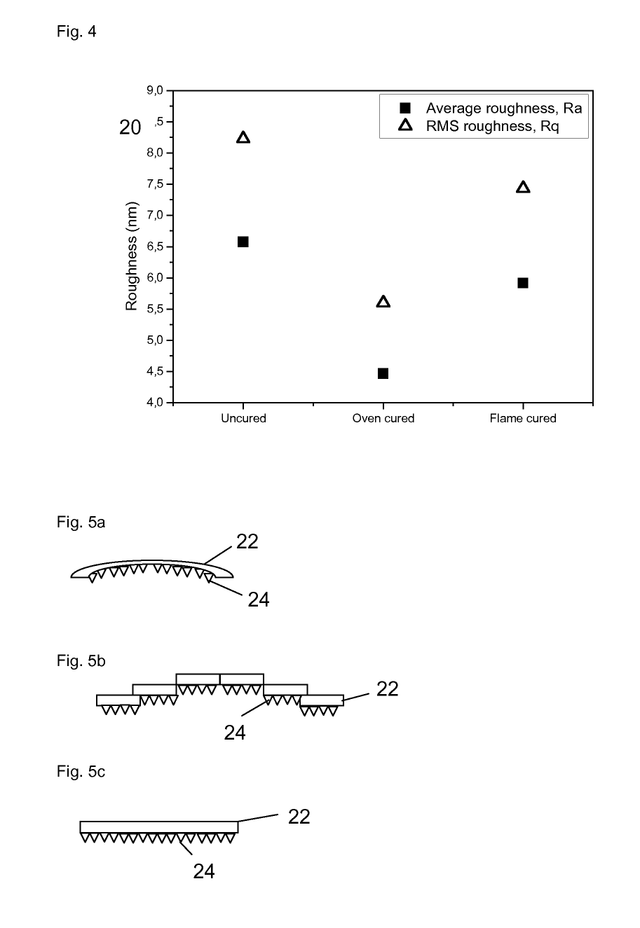

In FIG. 4 the results for glass substrates are compared. It is observed that the result of for flame converted samples according to the invention yields higher surface roughness as compared to the sample prepared by conventional oven conversion.

### Example 10: Laser as High Intensity Energy Source

A float-type glass substrate of 10×20 cm, with a thickness of 3.2 mm, is coated with MP Coat AR T1 coating composition (commercially available from DSM, The Netherlands; MP Coat AR T1 was formerly sold under the trade name KhepriCoat®) by dip coating at a dipping speed of 4 mm/s under controlled relative humidity (below 40%) and room temperature of 20-25° C. Whereafter the substrate is dried at room temperature for 24 h under the same conditions as coating condition (below 40% RH and 25° C.).

After drying, the coating composition was converted using a pulsed CO₂ laser with a power output of 1250 W with a constant frequency of 5 KHz and a beam diameter of 10 mm scanning over the 10 cm width of the substrate. The treatment area was hence 10 cm², and the power density 125 W/cm² The laser beam is scanning the substrate surface at a speed of 200 mm/s following parallel lines separated by a distance of 4 mm, resulting in an overlap of laser treatments from one scanning line to the next one. Hence the sample speed in 0.48 m/min. This resulted in a coated substrate with a stable appearing functional coating.

After conversion, the normalized reflection of the first surface of the functional coating was measured using fibre optics spectroscopy (AvaSpec128 from Avantes) measuring light intensity in the UV-VIS region, and normalized with the reflection signal of the first surface of an uncoated and untreated glass substrate. It was found that the normalized reflection curve of the functional coating (after laser conversion) was presenting a minimum value of 0.55% at a wavelength of 707 nm (i.e. 99.45% of the reflection of the first surface of uncoated glass is prevented). Since the full reflection (two sided) of the uncoated, untreated glass substrate measured by a UV-VIS spectrophotometer (UV-2401 from Shimadzu) was 8.856% at a wavelength of 707 nm, it corresponds to a reflection value of 4.46% at 707 nm for the sample coated with a laser converted coating composition on one side.

### Example 11: Laser as High Intensity Energy Source

A float-type glass substrate of 10×20 cm, with a thickness of 3.2 mm, was coated with MP Coat AR T1 coating composition (commercially available from DSM, The Netherlands; MP Coat AR T1 was formerly sold under the trade name KhepriCoat®) by dip coating at a dipping speed of 4 mm/s under controlled relative humidity (below 40%) and room temperature of 20-25° C. Thereafter the substrate was dried at room temperature for 24 h under the same conditions as coating condition (below 40% RH and 25° C.).

After drying, the coating composition was converted using a pulsed CO₂ laser with a power output of 1250 W with a constant frequency of 5 KHz and a beam diameter of 10 mm. The laser beam was scanning the substrate surface at a speed of 200 mm/s following parallel lines separated by a distance of 4 mm, resulting in an overlap of laser treatments from one scanning line to the next one. The treatment area was 10 cm² and the power density was 125 W/cm². Sample speed was 48 cm/min. This resulted in a defective functional coating with the development of microcracks at the interface between the glass first surface and the functional coating, resulting in bad visual appearance.

After conversion, the normalized reflection of the first surface of the functional coating was measured using fibre optics spectroscopy (AvaSpec128 and Avalight-DHc from Avantes) measuring light intensity in the UV-VIS region, and normalized with the reflection signal of the first surface of an uncoated and untreated glass substrate. Despite the microcracks and resulting bad visual appearance, it was found that the normalized reflection curve of the functional coating (after laser conversion) was presenting a minimum value of 0.49% at a wavelength of 689 nm. Since the full reflection of uncoated, untreated glass substrate measured by a UV-VIS spectrophotometer (UV-2401 from Shimadzu) is 8.864% at a wavelength of 689 nm, it corresponds to a reflection value of 4.45% at 689 nm for the laser converted sample which is similar to the value of Example 10.

### Example 12: Laser as High Intensity Energy Source

A float-type glass substrate of 10×20 cm, with a thickness of 3.2 mm, is coated with MP Coat AR T1 coating composition (commercially available from DSM, The Netherlands; MP Coat AR T1 was formerly sold under the trade name KhepriCoat®) by dip coating at a dipping speed of 4 mm/s under controlled relative humidity (below 40%) and room temperature of 20-25° C. Whereafter the substrate is dried at room temperature for 24 h under the same conditions as coating condition (below 40% RH and 25° C.).

After drying, the coating composition was converted using a pulsed CO₂ laser with a power output of 1250 W with a constant frequency of 5 KHz and a beam diameter of 10 mm. The treatment area was 10 cm² and the power density 125 W/cm². The laser beam scanned the substrate surface at a speed of 175 mm/s following parallel lines separated by a distance of 4 mm, resulting in an overlap of laser treatments from one scanning line to the next one. Sample speed was 42 cm/min. This resulted in the glass substrate breaking during the laser conversion.

### Example 13: Height Adjustment

Substrate as described in Example 2. Conditions for conversion: In the setup, the substrate was moved with constant linear speed under a linear flame array. The flame array was oriented at an angle of α=85° so the flame pointed in the direction that the glass was moved (as indicated in FIG. 6). A gas mix of natural gas and air was burned yielding a power of 18-21.5 kW/m and a theoretical flame maximum temperature of about 1960° C. Measured flame maximum temperature was 1180° C. by a type K thermocouple and Testo 925. The distance between flame and substrate was 8 mm.

Two modules were treated at an effective linear speed of 60 cm/min and initial flame array to substrate first surface distance of 8 mm. One module was treated with automatic height adjustment and one without automatic height adjustment. During flame conversion, the module bended due to heat expansion of by the first surface, i.e. the surface facing towards the flame array. The module treated using automatic height adjustment using a 1 Hz feedback loop involving a sensor arranged under the flame array measuring the height displacement of the substrate during conversion did not have contact with the flame array during conversion. Optical properties, as measured by Avantes single side reflectometer (Avaspec-2048L spectrometer with Avalight-DHc and AvaSpec128, (Pilkington, 50×50 cm, with a thickness of 3.2 mm and a composition compliant with DIN EN 572 was used as 100% reflectivity reference material) resulted in an average relative reflection in the range of 380-850 nm of 19% (i.e. the reflection of sample with flame converted coating composition had a reflection of 19% of the uncoated sample). The module treated without automatic height adjustment bended more than 8 mm and was scratched severely due to contact with the flame array and was therefore not useful anymore.

### Example 14: Influence of Tilt Angle, α

Float-type substrates (from Pilkington, 60×82 cm, standard K-edged, with a thickness of 3.2 mm, with a composition compliant with DIN EN 572) and photovoltaic modules having an uncoated cover glass (dimension 120×60×0.68 cm) were flame treated with a 65 cm wide linear flame array using a gas mix of natural gas and air as described in Example 13. The substrates were treated at a speed of 60 cm/min and flame array to substrate first surface distance of 15 mm and automatic height adjustment of the flame array with a feedback loop of 1 Hz. The tilt angle of the burner for the experiments is given in table together with the effect of the angle on the glass/modules. Results are presented in Table 1.

TABLE 1

| Substrate type | Tilt angle 90° | Tilt angle 60° |
|---|---|---|
| Float type glass | Breakage | No breakage |
| PV module | No breakage | No breakage |

### Example 16: Flame Conversion

A float-type glass substrate of 10×10 cm, with a thickness of 3.2 mm, is coated on both sides with a coating composition of sol-gel silica particles with an average diameter of 20 nm and including polymeric 1-5 nm particles as porogen by dip coating under controlled relative humidity (below 40%) and room temperature of 20-25° C. Whereafter the substrate is dried at room temperature for 24 h under the same conditions as coating condition (below 40% RH and 25° C.).

After drying, the coating composition was converted using a linear flame array of a length of 60 cm (i.e. wider than the substrate) as high intensity energy source. In the setup, the substrate was moved with a constant linear speed of 60 cm/min under the flame array. The flame array was oriented at an angle of 60° so the flame pointed towards the direction that the substrate was moved and with a distance of 15 mm between the straight linear flame array and the substrate. A gas mix of methane and air was burned yielding a power of 20 kW/m linear flame array and a theoretical flame maximum temperature of about 1800° C.

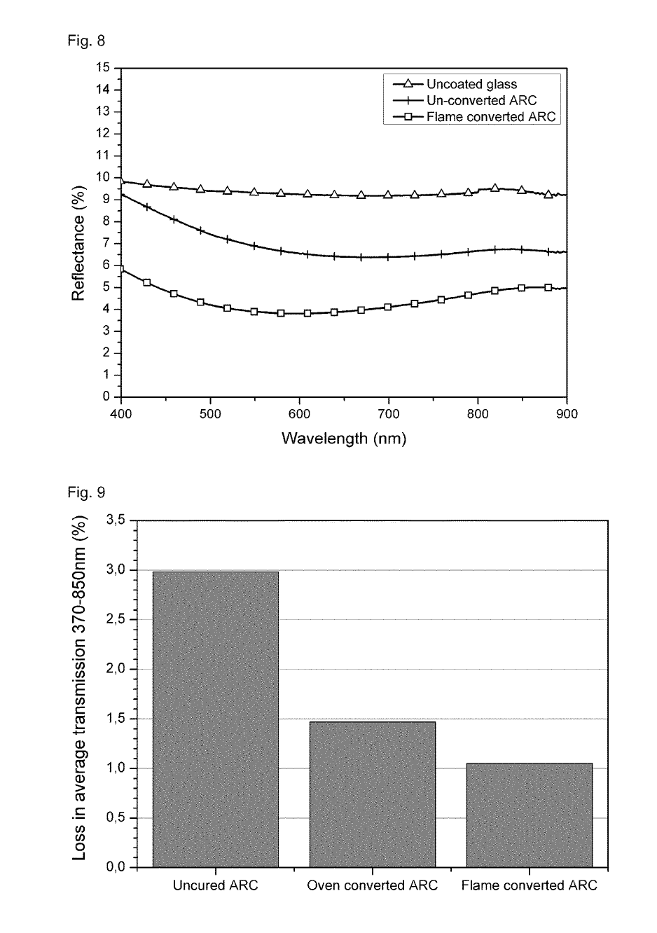

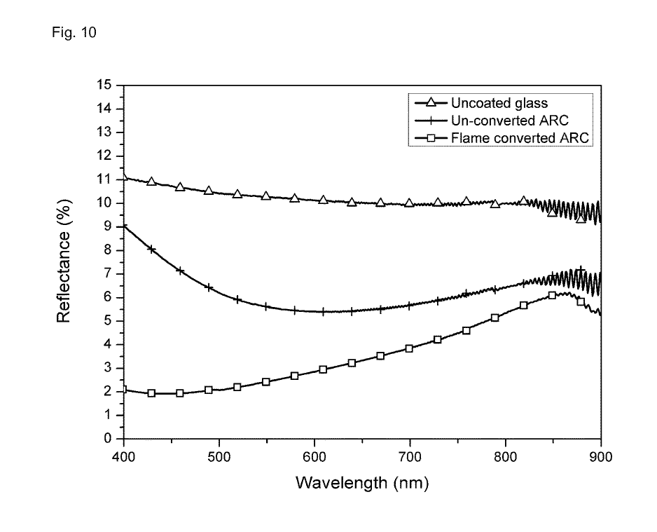

The optical reflectance of the sample was analysed by UV-Vis spectrophotometry (UV-2401 from Shimadzu) equipped with an integrating sphere. FIG. 8 depicts the reflectance curves in the visible and near-infrared spectrum, for a wavelength comprised between 400 and 900 nm. It is observed that the sample flame converted according to the invention exhibits a lower optical reflection than an uncured coated sample. The average reflection on a wavelength range comprised between 370 to 850 nm was measured at 4.47% for the flame converted sample according to this invention, while the average reflection on the same range was measured at 7.15% for the un-converted sample and at 9.38% for the uncoated glass.

### Example 17: Flame Conversion

A float-type glass substrate of 10×10 cm, with a thickness of 3.2 mm, was coated on a single side with a coating composition of sol-gel silica particles with an average diameter of 40-50 nm and sol-gel silica particle of 1-5 nm by dip coating under controlled relative humidity (below 40%) and room temperature of 20-25° C. Thereafter the substrate was dried at room temperature for 24 h under the same conditions as coating condition (below 40% RH and 25° C.).

After drying, the coating composition was converted using a linear flame array of a length of 60 cm (i.e. wider than the substrate) as high intensity energy source. In the setup, the substrate was moved with a constant linear speed of 60 cm/min under the flame array. The flame array was oriented at an angle of 60° so the flame pointed towards the direction that the substrate was moved (as indicated in FIG. 6) and with a distance of 15 mm between the straight linear flame array and the substrate. A gas mix of methane and air was burned yielding a power of 20 kW/m linear flame array and yielding a theoretical flame maximum temperature of about 1800° C.

The optical transmittance of the sample was analysed by UV-Vis spectrophotometry (UV-2600 from Shimadzu) equipped with an integrating sphere. The same value of average transmission on a wavelength range comprised between 370 to 850 nm was measured at 94.65% for the flame converted sample, for the oven converted sample, and for the untreated sample.

After conversion, the sample surface was tested for abrasion resistance with a felt pad according to the standard EN1096-2. This test consists of subjecting the surface of coated glass to rubbing with a felt pad under dry conditions. The felt is moved on the surface of the coating in an alternating forward and backward motion with a frequency of 60 strokes per minute, over a stroke length of 120 mm. Additionally to the linear movement; the felt pad continuously rotates at 6 rpm. The test is carried out with a load of 4N applied perpendicularly to the glass surface via the felt pad. FIG. 9 depicts the absolute difference in average transmittance in the visible and near-infrared spectrum, for a wavelength comprised between 370 and 850 nm, before and after 500 strokes. It is observed that the sample flame converted according to the invention exhibits an improved optical loss after this abrasion test as compared to oven converted and non-converted sample. This indicates that the sample converted according to the invention has a higher mechanical strength than the untreated sample as well as the oven converted sample.

### Example 18: Thin Glass

A thin flexible borosilicate glass substrate (D263T commercially available from Schott, 10×10 cm, with a thickness of 50 μm) is coated on both sides with a MP Coat AR T1 coating composition (commercially available from DSM, The Netherlands; MP Coat AR T1 was formerly sold under the trade name KhepriCoat®), by dip coating at a dipping speed of 4.7 mm/s under controlled relative humidity (below 40%) and room temperature of 20-25° C. Thereafter the substrate is dried at room temperature for 24 h under the same conditions as coating condition (below 40% RH and 25° C.).

After drying, the coating composition was converted using a linear flame array of a length of 60 cm (i.e. wider than the substrate) as high intensity energy source. In the setup, the substrate was moved with a constant linear speed of 180 cm/min under the flame array. The flame array was oriented at an angle of 60° so the flame pointed towards the direction that the substrate was moved and with a distance of 60 mm between the straight linear flame array and the substrate. A gas mix of methane and air was burned yielding a power of 20 kW/m linear flame array and a theoretical flame maximum temperature of about 1800° C.

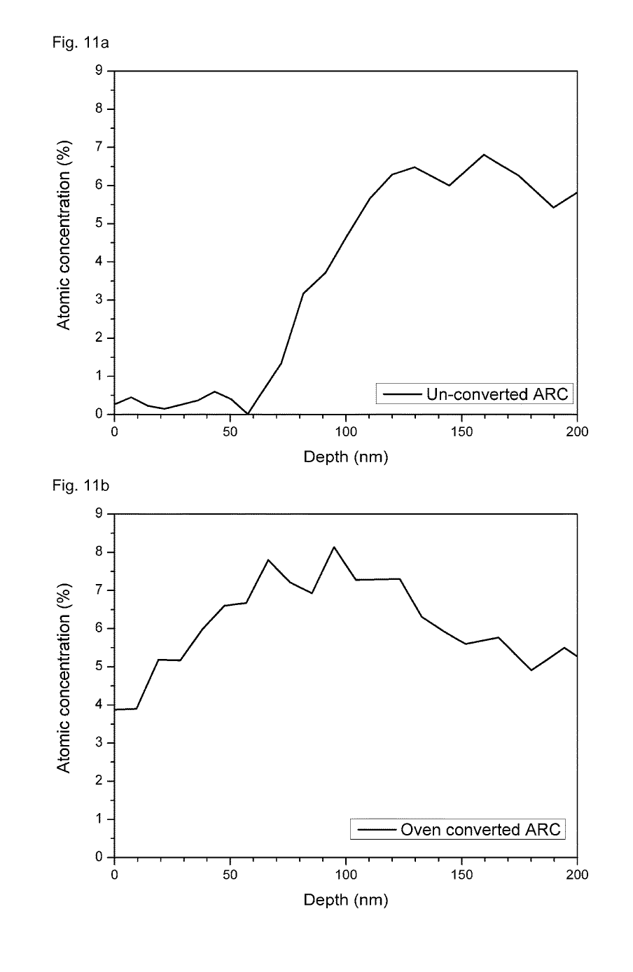

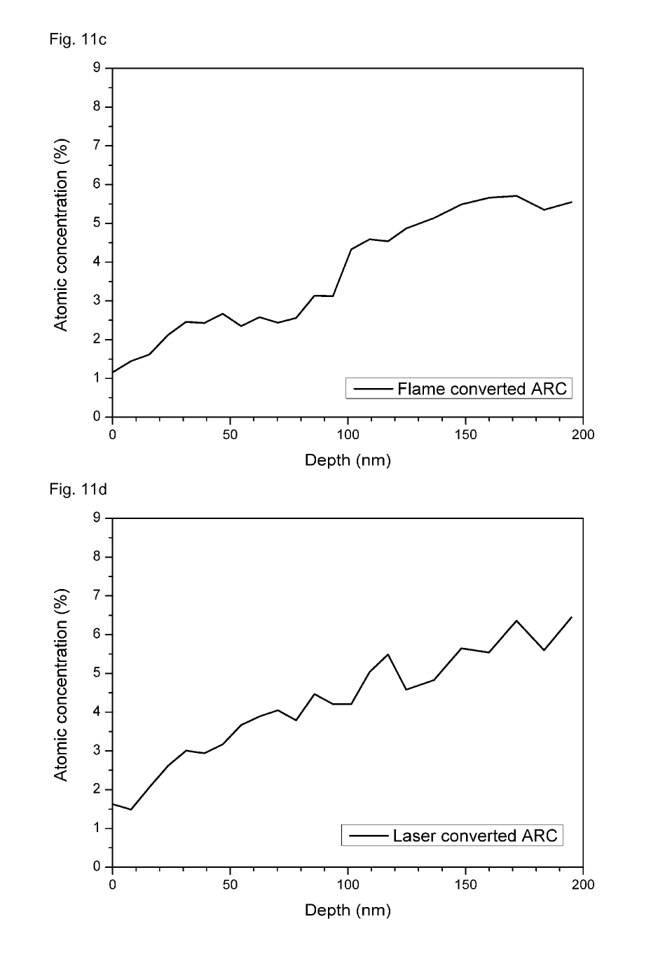

The optical reflectance of the sample was analysed by UV-Vis spectrophotometry (UV-2401 from Shimadzu) equipped with an integrating sphere. FIG. 11 depicts the reflectance curves in the visible and near-infrared spectrum, for a wavelength comprised between 400 and 900 nm. It is observed that the sample flame converted according to the invention exhibits a lower optical reflection than an uncured coated sample. The average reflection on a wavelength range comprised between 370 to 850 nm was measured at 3.31% for the flame converted sample according to this invention, while the average reflection on the same range was measured at 6.43% for the un-converted sample and at 10.29% for the uncoated glass.

### Example 19 (Comparative): Assembly in Oven

A sample from Example 2 is converted in the conventional way by heating in an oven for 3.5 min at 650° C.

This results in a coated substrate with a stable appearing coating, but other elements of the assembly such as the encapsulant and sealant will be degraded or even destroyed during conversion of the coating composition.

### Example 20: Element Profile by Sputtering

A float-type glass substrate of 10×20 cm, with a thickness of 3.2 mm, was coated on a single side with a coating composition of core-shell silica particles with a polymer core and silica based shell embedded in silica nanoparticles of 1-5 nm by dip coating at a dipping speed of 3.5 mm/s under controlled relative humidity (below 40%) and room temperature of 20-25° C. Thereafter the substrate was dried at room temperature for 24 h under the same conditions as coating condition (below 40% RH and 25° C.).

After drying, the coating composition was converted using a CO₂ laser with a power output of 135 W with a beam diameter of 300 μm, a treatment area of 0.3 cm² and a power density of 675 W/cm². Sample speed was 4 mm/s. This resulted in a coated substrate with a stable appearing functional coating. See FIG. 11d.

Another sample using same coating composition and application method was converted using a straight linear flame array of a length of 60 cm as high intensity energy source. In the setup, the substrate was moved with a constant linear speed of 60 cm/min under the flame array. The flame array was oriented at an angle of 60° so the flame pointed towards the direction that the substrate was moved (as indicated in FIG. 6). A gas mix of methane and air was burned yielding a power of 20 kW/m linear flame array and a theoretical flame maximum temperature of about 1800° C. The distance between substrate and flame was kept at 10 mm by an active feedback of 1 Hz. See FIG. 11c

Another sample using same coating composition and application method was converted in the conventional way by heating in an bench top oven for 3.5 min at 650° C. See FIG. 11b

Another sample using same coating composition and application method was kept unconverted after drying. See FIG. 11a.

A piece of 1×1 cm is cut from each sample abovementioned and analysed in an x-ray photoelectron spectroscopy equipment (PHI Quantum 2000) using a monochromated aluminium source with a Kα radiation at 1486.6 eV. The analysed area is 300×1400 μm. The charge correction is done based on the signal of C1s peak at 284.8 eV. After analysis of the top surface of the AR coating, a layer is etched by an Ar+ ion gun of 2 keV with a 2.6×1 mm raster at a sputtering rate of 133 Å/min. The newly formed top surface prepared this way is measured by XPS. This operation is repeated several times until reaching a depth of 200 nm.

In FIG. 11, the results for sodium content as a function of distance from the surface of the coating is shown for each sample. The glass substrate contains about 6% sodium whereas the coating composition does not contain any sodium. Hence, all sodium present in the first about 100 nm has been transported from the substrate to the coating during conversion. This is observed in FIG. 11a, where no conversion is conducted and a sharp change in sodium content therefore is observed at about 70-100 nm. On the contrary, it is observed in FIG. 11b that sodium is almost sucked from the substrate and into the coating during high temperature conversion in oven. A sodium rich coating is formed having a sodium content of 4-8%, which is even higher than the original content in substrate. In FIG. 11c and FIG. 11d, it is observed that using a high intensity energy source for the conversion the sodium content in the coating is strongly reduced and no up-concentration of sodium in the coating layer is observed. It is highly surprising that it was possible to reduce the sodium content in the resulting functional coating significantly without compromising the optical properties of the resulting coating composition and this may allow for the use of more affordable, lower quality glass substrates (i.e. substrates having higher contents of metal not desired in the coating for performance or durability reasons) while maintaining good resulting coatings, or to obtain coatings with improved composition after conversion for same type/quality of glass substrates.

### Example 21

For measuring the internal temperature during the conversion, a glass-glass laminate has been prepared. It comprises two float-type glass plate of 50×50 cm with two foils of transparent ethylene-vinyl acetate (NovoVellum Optima FC03 from NovoPolymers), with a thickness of 200 μm each, arranged in-between the two glass plates. A type K thermocouple made from chromel and alumel is placed in contact with the internal side of the top glass plate, in the centre of the plate, i.e. 25 cm from each edge.

The assembly was laminated using a standard lamination process at a temperature of 150° C. under a pressure of 800 mbar for 30 min.

During the conversion step, the thermocouple is connected to a digital data logging thermometer (YC-747UD from YCT) which converts the electric potential difference generated by the thermoelectric effect between the two wires into a readable temperature in degrees Celsius. This apparatus records the evolution of this value during the whole process with a sampling rate of 1 Hz. In Table 2, the maximum centre temperatures of the standard sample as measured under various conditions are shown.

TABLE 2

| | | | | Maximum | |
|---|---|---|---|---|---|
| Distance | Sample | | Flame | centre | Corre- |
| flame array | speed | Tilt | array | temper- | sponding |
| to substrate | (cm/ | angle, | power | ature | Exper- |
| (mm) | min) | α (°) | (kW)/60 cm | (° C.) | iment |
| 15 | 60 | 60 | 18-21.5 | 87 | Example 14 |
| 8 | 60 | 85 | 18-21.5 | 91 | Example 13 |
| 8 | 120 | 85 | 36-43 | 92 | Double |
| | | | | | flow of |
| | | | | | Example 13 |

An individual feature or combination of features from an embodiment of the invention described herein, as well as obvious variations thereof, are combinable with or exchangeable for features of the other embodiments described herein, unless the person skilled in the art would immediately realize that the resulting embodiment is not physically feasible.

1. A method of coating a substrate comprising the steps of
providing a substrate having a first surface,
providing a particle based coating composition comprising particles,
applying the coating composition to at least a part of the first surface of the substrate,
converting the particle based coating composition on the first surface of the substrate into a functional coating having a thickness of 50 nm to 25 μm as measured along a cross section in a scanning electron microscope (SEM), preferably 50 to 300 nm,
wherein the particle based coating composition comprises nanoparticles, preferably the coating composition comprises a sol gel comprising a metal oxide or a precursor of a metal oxide, more preferably the coating composition comprises core-shell nanoparticle having a core material comprising polymer and a shell material comprising metal oxide, and converting the particle based coating composition involves a high intensity energy source heating at least a part of the coating composition, wherein the high intensity energy source is selected from the group consisting of i) a CO₂ laser supplying an power of 100 W to 10.000 W onto a treatment area of 0.25 cm² to 30 cm²; preferably onto a treatment area of 1.5 cm² to 15 cm²; more preferably onto a treatment area of 2 cm² to 12 cm², and having a power density of 100 W/cm² to 1000 W/cm²; and the nanoparticles are core-shell nanoparticles having a core material comprising polymer and a shell material comprising metal oxide and ii) a flame array supplying a power of 5 kW/m to 100 kW/m flame array, preferably 15 kW/m to 75 kW/m, more preferably 20 kW/m to 50 kW/m directed towards the substrate, and arranged with a minimum distance from the flame array to the substrate of 3 mm to 30 mm, preferably 4 mm to 20 mm, more preferably 5 mm to 15 mm, such as 6 mm to 12 mm during use and the coating composition comprises a sol gel comprising a metal oxide or a precursor of a metal oxide.

2. Method according to claim 1, wherein the substrate is moving continuously or semi continuously during converting with an effective linear speed of at least 0.5 m per min, preferably with an effective linear speed of at least 0.75 m per minute and more preferably with a speed of at least 1 m per minute; and with a linear speed of less than 20 m per min, preferably with a linear speed of less than 10 m per minute, more preferably with a linear speed of less than 5 m per minute and more preferably with a speed of less than 2 m per minute.

3. Method according to claim 1, wherein the coating composition is applied in a pattern covering 50 to 95% of the first surface of the substrate, preferably by further comprising the step of applying a template member covering 5 to 50% of the first surface of the substrate before applying the coating composition or by further comprising the step of applying a template member covering 5 to 50% of the first surface of the substrate with applied coating composition before converting the coating composition on the first surface of the substrate; and optionally further comprising the step of recycle coating composition provided on the template member.

4. Method according to claim 1, further comprising the step of providing a protective frame on or near the substrate before converting the coating composition, preferably the protective frame is provided before providing of the coating composition on the substrate.

5. Method according to claim 1, wherein the substrate is selected from the group consisting of float glass, chemically strengthened float glass, structured glass, tempered glass and thin flexible glass, wherein the thin flexible glass has a thickness in the range of 20 to 250 μm, preferably 50 to 100 μm.

6. Method according to claim 1, wherein the substrate is an assembly comprising a glass member forming at least a part of the first surface of the substrate and at least one member selected from the group consisting of a back sheet, an encapsulant, an electrical conducting film, wiring, controller box and a frame; wherein the glass member being selected from the group of float glass, chemically strengthened float glass, borosilicate glass, structured glass, tempered glass and thin flexible glass, wherein the thin flexible glass has a thickness in the range of 20 to 250 μm, preferably 50 to 100 μm.

7. Method according to claim 1, wherein the maximum centre temperature of a standard sample is lower than 200° C., preferably lower than 150° C., more preferably lower than 130° C., more preferably the maximum centre temperature is lower than 120° C., more preferably the maximum centre temperature is lower than 100° C.

8. Use of the method according to claim 1 to coat a substrate with an optical coating having an thickness of 50 nm to 250 nm as measured along a cross section in a scanning electron microscope (SEM).

9. A photovoltaic module comprising a substrate coated according to the method of claim 1.

10. Method according to claim 1, wherein the high intensity energy source is a flame, preferably a linear flame array arranged at an angle of 30-80° to a plane of the first surface of the substrate during converting, and more preferably with the angle of 30-80° to a plane of the first surface of the substrate during converting so the flame tip is pointing towards the direction that the substrate is moving.

11. Method according to claim 10, wherein the energy source is a flame array comprising at least a part of a flame array selected from the group consisting of a vertically displaceable flame arrays to accommodate for bending of the substrate during converting; at least one permanently curved flame array; at least one staged flame array; and at least one linear flame array with adjustable flame length and/or flame temperature along the array.

12. An apparatus for providing a functional coating to a substrate comprising
a coating application station for applying a particle based coating composition to a first surface of a substrate,
a converting station for converting the particle based coating composition on the first surface of the substrate into a functional coating,
an assembly station for providing at least one member selected from the group consisting of a back sheet, an encapsulant, an electrical conducting film, wiring, controller box and a frame, in connection with a second surface of the substrate,
a substrate conveyer for transporting the substrate between at least two of the stations,
wherein at least one assembly station is arranged sequentially before the coating application station and wherein the converting station comprises a high intensity energy source arranged to—during use—heat at least a part of the coating composition to a surface temperature of at least 800° C. with a heating ramp of at least 1000° C./s and hold the temperature above 600° C. for 0.5 to 5 s, preferably the high intensity energy source comprises a flame or a laser.

13. Apparatus according to claim 12, further comprising a substrate pre-treatment station for treating the first surface of the substrate before the coating application station, wherein the substrate pre-treatment station is arranged between the assembly station and the coating application station.

14. Apparatus according to claim 12, wherein the substrate conveyer interacts with the first surface of the substrate in at least one station before the coating application station and the substrate conveyer does not interact with the first surface of the substrate in and after the coating application station.

15. Method of manufacturing a photovoltaic module comprising the steps of
providing a substrate,
thereafter applying a coating composition to at least a part of a first surface of the substrate,
converting the coating composition on the first surface of the substrate into a functional coating,
wherein the substrate is an assembly comprising a glass member forming at least a part of the first surface of the substrate and at least one component selected from the group of a thin film transparent conductive and/or semiconductor layer, a back sheet, an encapsulant, an electrical conducting film, wiring, a controller box and a frame, the converting involves heating by a laser or a flame array.

16. Method according to claim 15, wherein the coating composition comprises nanoparticles, preferably the coating composition comprises a sol gel comprising a metal oxide or a precursor of a metal oxide, more preferably the coating composition comprises core-shell nanoparticle having an core material comprising polymer and a shell material comprising metal oxide,
